(19) United States
(12) Patent Application Publication
(10) Pub. No.: US 2026/0186830 A1
(43) Pub. Date: Jul. 2, 2026

(54) MANAGEMENT SYSTEM, SERVER, AND STORAGE MEDIUM STORING PROGRAM

(71) Applicant: BROTHER KOGYO KABUSHIKI KAISHA, Nagoya (JP)

(72) Inventor: Yuki YADA, Kuwana (JP)

(21) Appl. No.: 19/368,161

(22) Filed: Oct. 24, 2025

(30) Foreign Application Priority Data
Dec. 26, 2024 (JP) 2024-230041

(51) Int. Cl. G06F 9/48

(52) U.S. Cl. CPC G06F 9/4881

(57) ABSTRACT

A server receives a first execution instruction instructing execution of a first task from outside. In response to receiving the first execution instruction, the server transmits a first execution request to a first device. After receiving the first execution instruction, the server receives a second execution instruction instructing execution of a second task from outside. In response to receiving the second execution instruction, the server transmits a second execution request to the first device and a second device. The transmitting the second execution request includes: while the first device is executing the first task, not transmitting the second execution request to the first device and transmitting the second execution request to the second device that is not executing the first task; and after the first device completes execution of the first task, transmitting the second execution request to the first device.

### REFERENCE TO RELATED APPLICATIONS

This application claims priority from Japanese Patent Application No. 2024-230041 filed on Dec. 26, 2024. The entire content of the priority application is incorporated herein by reference.

### BACKGROUND ART

A server that manages tasks to be executed by devices is known.

### SUMMARY

A device management system includes a management server, one or more management clients, and one or more devices. The management server can create a batch task in which tasks of one or more stages are defined for one or more devices. The management server executes a task execution instruction to the management client. The management client divides one or more tasks defining a batch task instructed to be executed into subtasks for each device of the execution target. The management client causes the one or more devices to simultaneously execute the divided subtasks.

The batch task is a task that is executed by linking a plurality of tasks. There may be a case where an administrator does not link a plurality of tasks and causes the tasks of the execution target separately. In the above example, a case where execution of a plurality of tasks is separately instructed is not considered.

In view of the foregoing, an example of an object of this disclosure is to cause a device to efficiently execute a plurality of tasks even when execution of the plurality of tasks is separately instructed.

According to one aspect, this specification discloses a management system. The management system includes a plurality of devices and a server. The plurality of devices are configured to execute a particular task. The plurality of devices include a first device and a second device different from the first device. The server is configured to perform receiving a first execution instruction from outside, the first execution instruction instructing execution of a first task that is the particular task for the first device. Thus, the first execution instruction is received from outside. The server is configured to perform, in response to receiving the first execution instruction, transmitting a first execution request to the first device, the first execution request requesting execution of the first task. Thus, the first execution request is transmitted to the first device. The server is configured to perform, after receiving the first execution instruction, receiving a second execution instruction from outside, the second execution instruction instructing execution of a second task that is the particular task for both the first device and the second device. Thus, the second execution instruction is received from outside. The server is configured to perform, in response to receiving the second execution instruction, transmitting a second execution request to the first device and the second device, the second execution request requesting execution of the second task. Thus, the second execution request is transmitted to the first device and the second device. In response to receiving the first execution request, the first device is configured to execute the first task. In response to receiving the second execution request, each of the first device and the second device is configured to execute the second task. The transmitting the second execution request includes: while the first device is executing the first task, not transmitting the second execution request to the first device and transmitting the second execution request to the second device that is not executing the first task; and after the first device completes execution of the first task, transmitting the second execution request to the first device.

According to another aspect, this specification also discloses a non-transitory computer-readable storage medium storing a set of program instructions for a server including a controller. The server is configured to be connected to a plurality of devices for communication. The plurality of devices are configured to execute a particular task. The plurality of devices include a first device and a second device. The set of program instructions, when executed by the controller, causes the server to perform: receiving a first execution instruction from outside, the first execution instruction instructing execution of a first task that is the particular task for the first device; in response to receiving the first execution instruction, transmitting a first execution request to the first device, the first execution request requesting execution of the first task; after receiving the first execution instruction, receiving a second execution instruction from outside, the second execution instruction instructing execution of a second task that is the particular task for both the first device and the second device; and in response to receiving the second execution instruction, transmitting a second execution request to the first device and the second device, the second execution request requesting execution of the second task. The transmitting the second execution request includes: while the first device is executing the first task, not transmitting the second execution request to the first device and transmitting the second execution request to the second device that is not executing the first task; and after the first device completes execution of the first task, transmitting the second execution request to the first device.

According to still another aspect, this specification also discloses a server configured to be connected to a plurality of devices for communication. The plurality of devices are configured to execute a particular task. The plurality of devices include a first device and a second device. The server includes a controller. The controller is configured to perform receiving a first execution instruction from outside, the first execution instruction instructing execution of a first task that is the particular task for the first device. The controller is configured to perform, in response to receiving the first execution instruction, transmitting a first execution request to the first device, the first execution request requesting execution of the first task. The controller is configured to perform, after receiving the first execution instruction, receiving a second execution instruction from outside, the second execution instruction instructing execution of a second task that is the particular task for both the first device and the second device. The controller is configured to perform, in response to receiving the second execution instruction, transmitting a second execution request to the first device and the second device, the second execution request requesting execution of the second task. The transmitting the second execution request includes: while the first device is executing the first task, not transmitting the second execution request to the first device and transmitting the second execution request to the second device that is not executing the first task; and after the first device completes execution of the first task, transmitting the second execution request to the first device.

According to the present disclosure, the device efficiently executes a plurality of tasks even when execution of the plurality of tasks is separately instructed.

### BRIEF DESCRIPTION OF DRAWINGS

FIG. 1 is a block diagram showing a configuration of a management system.

FIG. 2 is a functional diagram of the management system.

FIG. 3 is a diagram showing the contents of an administrator database.

FIG. 4 is a diagram showing the contents of a device list.

FIGS. 5A, 5B, and 5C show changes in stored contents of an execution list.

FIGS. 6A and 6B show changes in stored contents of the execution list.

FIGS. 7A, 7B, 7C, 7D, 7E, and 7F show changes in stored contents of a status management database.

FIG. 8 is a flowchart showing the contents of a process executed by a server.

FIG. 9 is a sequence diagram showing a first part of a procedure for executing a plurality of tasks by a plurality of administrators.

FIG. 10 is a sequence diagram showing a second part of the procedure for executing the plurality of tasks by the plurality of administrators.

FIG. 11 is a sequence diagram showing a third part of the procedure for executing the plurality of tasks by the plurality of administrators.

FIG. 12 is a sequence diagram showing a fourth part of the procedure for executing the plurality of tasks by the plurality of administrators.

### DESCRIPTION

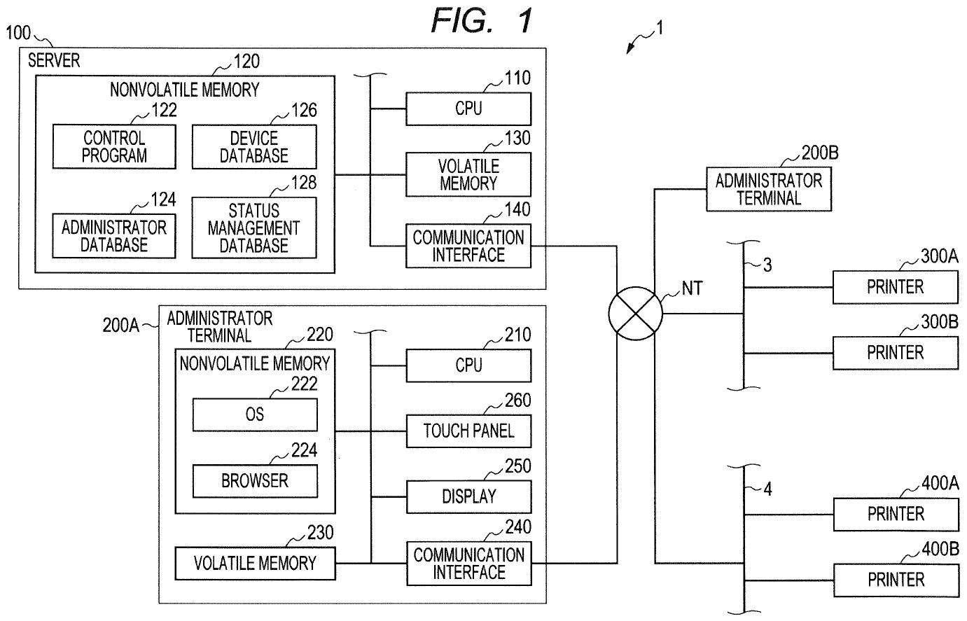

A management system according to an embodiment will be described. A management system 1 shown in FIG. 1 includes a server 100, an administrator terminal 200A, an administrator terminal 200B, a printer 300A, a printer 300B, a printer 400A, and a printer 400B. The printer 300A and the printer 300B are connected to a network 3. The printer 400A and the printer 400B are connected to a network 4. The network 3 and the network 4 are, for example, local area networks (LANs). The server 100, the administrator terminals 200A and 200B, and the networks 3 and 4 are connected to Internet NT. The server 100, the administrator terminal 200A, the administrator terminal 200B, the printer 300A, the printer 300B, the printer 400A, and the printer 400B communicate with one another via the Internet NT, the network 3, and the network 4. The printer 300A and the printer 300B are collectively referred to as a printer 300. The printer 300A, the printer 300B, the printer 400A, and the printer 400B are collectively referred to as printers 300 and 400. The same applies to the administrator terminals.

The server 100 is a physical or virtual server operated by a printer manufacturer. The virtual server is, for example, a cloud server using a cloud service such as Amazon Web Services (AWS). The server 100 includes a CPU 110, a nonvolatile memory 120, a volatile memory 130, and a communication interface 140. The interface may be abbreviated as “IF”. The “AWS” is a registered trademark of Amazon Technologies, Inc.

The CPU 110 is a computing device that executes data processing.

The nonvolatile memory 120 is, for example, a ROM. The nonvolatile memory 120 includes a control program 122, an administrator database 124, a device database 126, and a status management database 128. A database may be abbreviated as “DB”.

The control program 122 is a program that is provided by a printer manufacturer and controls the server 100. In a case where the server 100 is a virtual server, the printer manufacturer uploads the control program 122 on the cloud to install the server 100. The control program 122 includes a source code for executing the processing of the flowchart shown in FIG. 8. The control program 122 may be a single program or may be configured by a plurality of programs.

The administrator database 124 stores a list of administrators of the printers managed by the management system 1. The device database 126 stores a list of printers managed by the management system 1. The status management database 128 stores the status of the printers managed by the management system 1. The administrator database 124, the device database 126, and the status management database 128 will be described in detail later.

The volatile memory 130 is, for example, a RAM. The volatile memory 130 temporarily stores data generated by the processing of the CPU 110.

The communication interface 140 is connected to the Internet NT and communicates with external devices of the administrator terminal 200, the printer 300, and the printer 400.

The administrator terminal 200 is used by an administrator of the printer. The administrator terminal 200 is, for example, a personal computer (PC). The administrator terminal 200 includes a CPU 210, a nonvolatile memory 220, a volatile memory 230, a communication interface 240, a display 250, and a touch panel 260. The CPU 210 and the volatile memory 230 have the same functions as the CPU 110 and the volatile memory 130, respectively.

The nonvolatile memory 220 includes an operating system 222 and a browser 224. The operating system is abbreviated as “OS”. The OS 222 is a program for controlling the administrator terminal 200, and is, for example, Windows. The browser 224 is software for browsing a Web page. The “Windows” is a registered trademark of Microsoft Corporation.

The communication interface 240 is connected to the Internet NT and communicates with external devices of the server 100, the printer 300, and the printer 400.

The display 250 displays a screen such as a management screen described later. The touch panel 260 receives a touch operation from the administrator and transmits a signal corresponding to the touch operation to the CPU 210. The touch panel 260 is, for example, a liquid crystal panel.

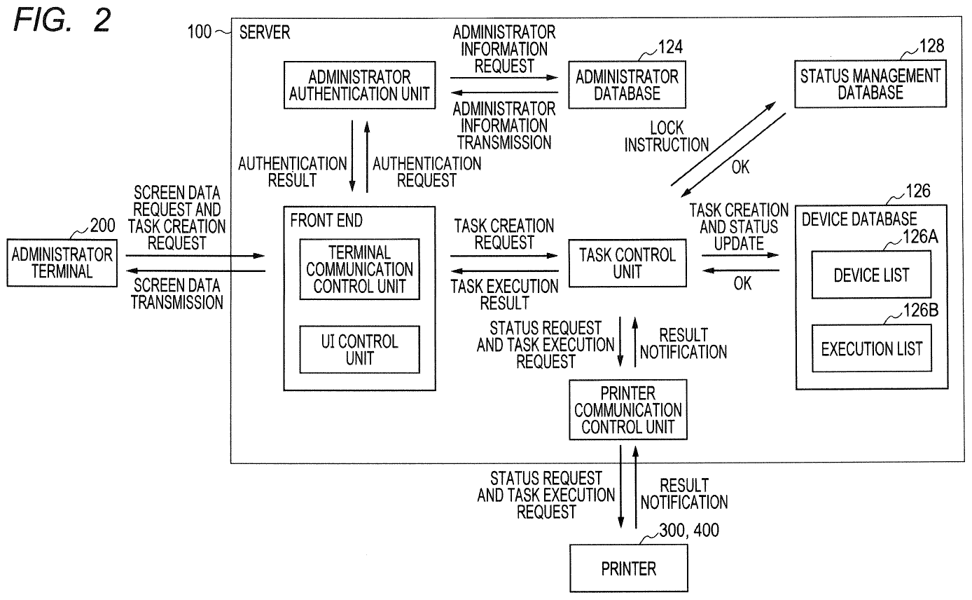

A functional configuration of the management system 1 will be described with reference to FIG. 2. The administrator terminal 200 has a function of requesting a front end of the server 100 to transmit screen data such as a management screen described later. The administrator terminal 200 also has a function of transmitting a task creation request to the front end to request the front end to create a task to be executed by the printers 300 and 400. The task is, for example, updating of firmware of printers, updating of setting values, or execution of backup.

The server 100 includes the front end, an administrator authentication unit, an administrator database 124, a task control unit, the device database 126, a status management database 128, and a printer communication control unit. In a case where the server 100 is a physical server, the front end, the administrator authentication unit, the task control unit, and the printer communication control unit are realized by the CPU 110 executing the control program 122. In a case where the server 100 is a virtual server, the respective components may be configured to cooperate as separate modules. In this case, the respective components may be realized by different programs.

The front end includes a terminal communication control unit and a UI control unit. The terminal communication control unit has a function of controlling communication with the administrator terminal 200 and transmitting screen data and a notification regarding an execution result of a task to the administrator terminal 200. The UI control unit executes control to transmit screen data according to a request from the administrator terminal 200.

The administrator authentication unit includes an authenticating function that authenticates administrator information included in an authorization request received from the front end in cooperation with the administrator database 124. The administrator authentication unit transmits an authentication result to the front end.

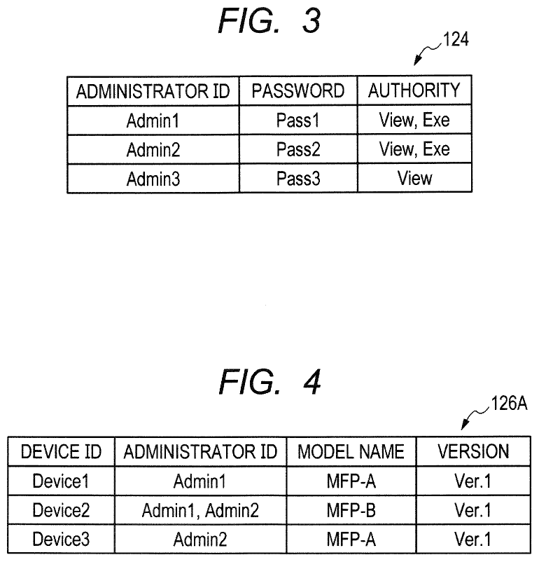

In the administrator database 124 shown in FIG. 3, an administrator ID, a password, and authority are stored in association with each other. The administrator ID is a character string for identifying an administrator. The password is a character string indicating a key that is used by the administrator to log in to the management screen. The password is a value obtained by adding a random character string called a salt to a plaintext password set by the administrator and hashing the plaintext password. In the present embodiment, for convenience, the password is described as a plaintext password.

The authority is a string of characters that indicates the functions that the administrator is permitted to execute. The character string “View” indicates a function of allowing the administrator to log in to the management screen and view the execution status of the task in the printers 300 and 400. The character string “Exe” indicates a function of instructing the printers 300 and 400 to execute a task. In FIG. 3, the administrator with the administrator ID “Admin1” and the administrator with the administrator ID “Admin2” are permitted to instruct the execution of the task, but the administrator with the administrator ID “Admin3” is not permitted to instruct the execution of the task.

Referring to FIG. 2, the task control unit has a capability of creating a task in cooperation with the device database 126. The task control unit has a function of managing an execution status of a task in cooperation with the printer communication control unit and the device database 126. The task control unit manages whether the printers 300 and 400 are in a status of accepting a task execution request in cooperation with the printer communication control unit and the status management database 128. The task control unit transmits the execution result of the task to the front end.

The device database 126 includes a device list 126A and an execution list 126B. In the device list 126A shown in FIG. 4, a device ID, an administrator ID, a model name, and a version are stored in association with each other. The device ID is a character string for identifying the printer, and is, for example, a serial number. In the present embodiment, the device ID for identifying the printer 300A is “Device1”, the device ID for identifying the printer 300B is “Device2”, and the device ID for identifying the printer 400A is “Device3”. The administrator ID is a character string for identifying an administrator who manages the printer. In FIG. 3, it is indicated that the administrator with the administrator ID “Admin1” and the administrator with the administrator ID “Admin2” cooperate to manage the printer with the device ID “Device2”, that is, the printer 300B. The model name is a character string indicating the model of the printer. The version is a character string indicating the version of the firmware of the printer.

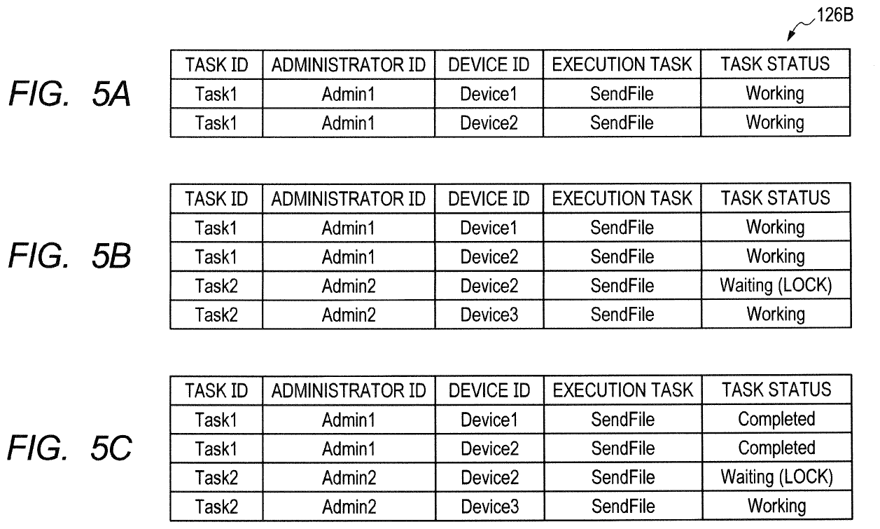

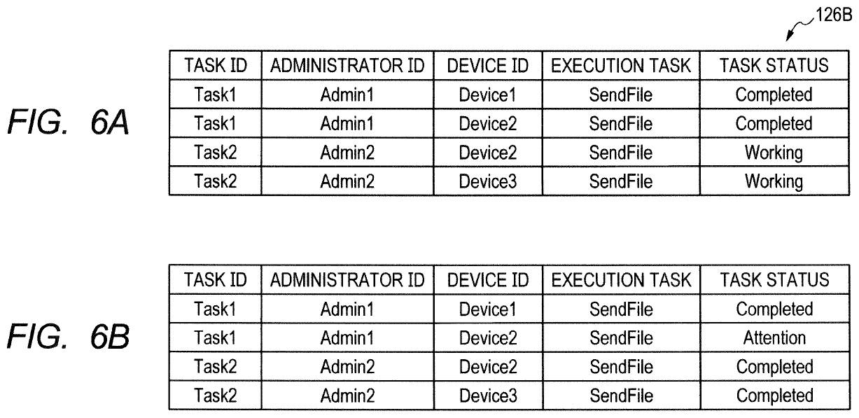

FIGS. 5A to 6B illustrate changes in the stored contents of the execution list 126B. In the execution list 126B, a task ID, an administrator ID, a device ID, an execution task, and a task status are stored in association with one another. The task ID is a character string for distinguishing tasks instructed by different task creation requests. When a task for a plurality of printers, that is, a plurality of tasks are designated by one task creation request, the same task ID is assigned to the plurality of tasks. The administrator ID is a character string for identifying the administrator who has transmitted the task creation request. The device ID is a character string for identifying a printer that is a target of execution of a task.

The execution task is a string that identifies the function of the task. For example, the character string “SendFile” indicates a file transmission task that is a task in which the server 100 transmits a file in which a setting value is described to the printer and causes the printer to update the setting value. In addition, the execution task includes a character string “FirmUpdate” indicating a firmware update task that is a task for causing the printer to execute an update of firmware, and a character string “Backup” indicating a backup task that is a task for causing the printer to execute creation of backup data. The backup data is, for example, data of a print job stored in the printer 300 or 400. The backup data may be scan data indicating a scan image when the printers 300 and 400 have a scan function.

The task status is a string that identifies the execution status of the task at the printer. For example, the character string “Working” indicates a state where the printer is executing the task identified by the execution task. The character string “Waiting (LOCK)” indicates that the printer is executing a task different from the task identified by the execution task, and is in a state where the task identified by the execution task cannot be executed. The character string “Completed” indicates a state where the printer has properly executed and completed the task identified by the execution task. The character string “Attention” indicates a state where the administrator is alerted regarding the execution status of the task. For example, in a case where the firmware is the latest version, even if the firmware update task is instructed to be executed, the firmware update task does not need to be executed, and thus “Attention” is stored in the execution list 126B. A character string “Error” (not shown) indicates that the printer has completed the execution of the task identified by the execution task but has failed.

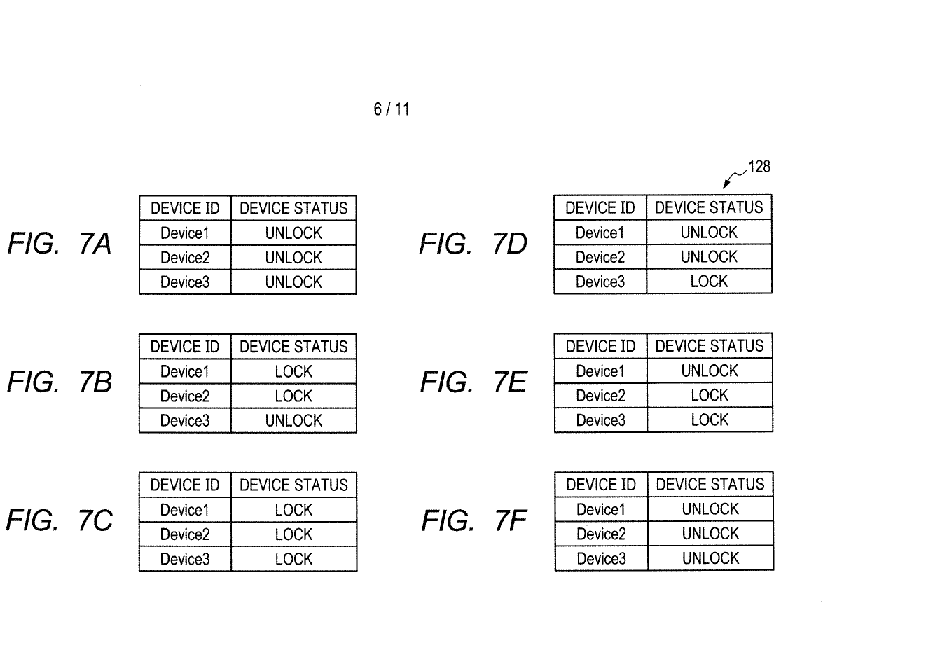

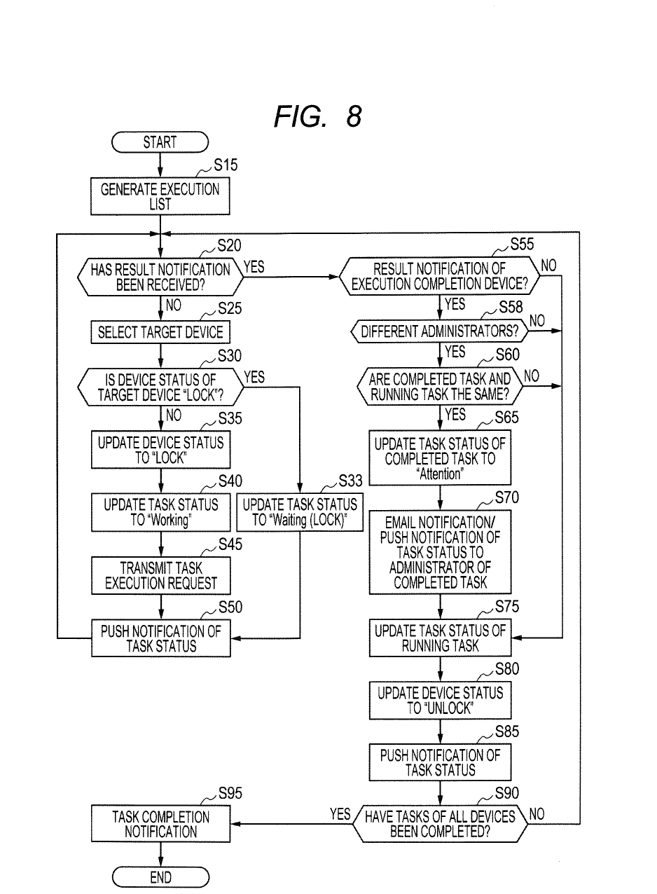

FIGS. 7A to 7F illustrate changes in stored contents of the status management database 128. In the status management database 128, the device ID and the device status are stored in association with each other. The device ID is the same string as the device ID stored in the device list 126A. The device status is a character string indicating whether the printer is in a status of accepting a task execution request. Specifically, the character string “UNLOCK” indicates that the printer is not executing a task and is in a status of accepting the task execution request. The character string “LOCK” indicates that the printer is executing a task and is in a status of not accepting the task execution request.

Referring to FIG. 2, the printer communication control unit has a function of controlling communication with the printers 300 and 400 and transmitting a task execution request to the printers 300 and 400, and a function of receiving a result notification indicating a task execution status from the printers 300 and 400.

The printers 300 and 400 execute the task in response to reception of the task execution request. The printers 300 and 400 transmit the result notification to the server 100.

The content of processing executed by the CPU 110 of the server 100 will be described with reference to FIG. 8. More specifically, the processing shown in the flowchart of FIG. 8 is executed by the task control unit. The processing shown in the flowchart of FIG. 8 is started in response to reception of a task creation request from the administrator terminal 200. When the task creation requests are received from a plurality of administrator terminals 200, the processing shown in the flowchart of FIG. 8 is executed in parallel. The task creation request includes the execution task that is a character string for identifying a function of the task, the device ID for identifying the printer that executes the task, and the administrator ID for identifying the administrator who has transmitted the task creation request.

At the time when the task creation request is received, the server 100 and the administrator terminal 200 have established bidirectional communication in which the server 100 executes a push notification, which is a notification to be spontaneously transmitted to the administrator terminal 200, without receiving a request from the administrator terminal 200. The server 100 and the administrator terminal 200 establish bidirectional communication in accordance with, for example, the WebSocket protocol. In a modification, the server 100 and the administrator terminal 200 may establish a constant connection in accordance with the XMPP protocol as bidirectional communication.

In S15, the CPU 110 of the server 100 generates the execution list 126B. Specifically, the task control unit generates, as the task ID, a character string that is not yet used as the task ID at that time. The task control unit stores the task ID, the administrator ID included in the task creation request, the device ID, and the execution task in association with one another, at the end of the execution list 126B. In the present embodiment, the task status is left blank at the time when the task ID is generated.

In S20, the CPU 110 determines whether a result notification indicating the execution status of the task has been received from the printer 300 or 400. In response to determining that the result notification has not been received (S20: NO), in S25 the CPU 110 selects a target device which is a printer that is caused to execute the task. For example, the CPU 110 selects the device ID whose task status is blank or “Waiting (LOCK)” from the execution list 126B.

In S30, the CPU 110 determines whether the device status of the target device is “LOCK”. Specifically, the CPU 110 reads, from the status management database 128, the device status associated with the device ID of the target device, and determines whether the device status is “LOCK”.

In response to determining that the device status of the target device is “LOCK” (S30: YES), then in S33 the CPU 110 updates the task status of the target device in the execution list 126B to “Waiting (LOCK)”. Specifically, the CPU 110 stores the task status “Waiting (LOCK)” in association with the device ID of the target device in the execution list 126B. The CPU 110 that has finished the processing of S33 proceeds to S50.

In response to determining that the device status of the target device is not “LOCK”, that is, “UNLOCK” (S30: NO), in S35 the CPU 110 updates the device status of the target device in the status management database 128 to “LOCK”. Specifically, the CPU 110 stores the device status “LOCK” in association with the device ID of the target device in the status management database 128.

In S40, the CPU 110 updates the task status of the target device in the execution list 126B to “Working”. Specifically, the CPU 110 stores the task status “Working” in association with the device ID of the target device in the execution list 126B. In S45, the CPU 110 transmits a task execution request for executing the task to the target device. In S50, the CPU 110 transmits a push notification of the task status of the target device by bidirectional communication. In a case where S50 is executed after S45, “Working” is pushed as the task status. In a case where S50 is executed after S33, “Waiting (LOCK)” is pushed as the task status.

In response to determining that a result notification has been received (S20: YES), in S55, the CPU 110 determines whether a result notification has been received from an execution completion device. The execution completion device is a device in which a completed task exists. The completed task is a task that has been completed at a time point before S55 is executed. Specifically, in S55, when a task (completed task) whose task status “Completed” or “Error” is stored in the execution list 126B in association with the device ID identifying the printer that is the transmission source of the result notification, the CPU 110 determines that the result notification has been received from the execution completion device. In response to determining that the result notification is not received from the execution completion device (S55: NO), the CPU 110 proceeds to S75.

In response to determining that the result notification is received from the execution completion device (S55: YES), the CPU 110 determines in S58 whether the administrator of a running task that is a task indicated by the result notification is different from the administrator of the completed task. Specifically, when the administrator ID of the running task stored in the execution list 126B does not match the administrator ID of the completed task, the CPU 110 determines that the administrators are different. The case where the administrator ID of the running task stored in the execution list 126B does not match the administrator ID of the completed task is, for example, a case where two administrators using different administrator terminals 200 have separately transmitted task creation requests. In response to determining that the administrators are the same (S58: NO), the CPU 110 proceeds to S75.

In response to determining that the administrators are different (S58: YES), in S60, the CPU 110 determines whether the completed task and the running task are related to the same function. For example, when “SendFile” is stored as the completed task and “SendFile” is stored as the running task in the execution list 126B, the CPU 110 determines that the completed task and the running task are related to the same function. When the CPU 110 determines that the completed task and the running task are not related to the same function (S60: NO), the CPU 110 proceeds to S75.

In response to determining that the completed task and the running task are related to the same function (S60: YES), in S65 the CPU 110 updates the task status of the completed task to “Attention”. Specifically, the CPU 110 updates the task status of the completed task for which the task status “Completed” or “Error” is stored in the execution list 126B in association with the device ID identifying the printer that is the transmission source of the result notification to “Attention”.

In S70, the CPU 110 notifies, by email, the administrator terminal of the administrator of the completed task that the task status of the completed task has been changed. In a modification, the CPU 110 may execute a push notification in a case where bidirectional communication is established with the administrator terminal of the administrator of the completed task. In the present embodiment, when the CPU 110 determines that the administrators are the same (S58: NO), the processing of S70 is not executed. When two task creation requests are transmitted by the same administrator, it is likely that the administrator instructs execution of the task with understanding that the setting value is overwritten. This prevents an unnecessary notification from being transmitted to the administrator.

In S75, the CPU 110 updates the task status of the running task based on the content of the result notification. In S80, the CPU 110 updates the device status associated with the device ID identifying the printer that is the transmission source of the result notification to “UNLOCK”. In S85, the CPU 110 executes a push notification of the task status of the running task by bidirectional communication.

In S90, the CPU 110 determines whether tasks of all the printers are completed. Specifically, when the task status of all the tasks having the same task ID generated in S15 are any one of “Completed”, “Attention”, and “Error”, the CPU 110 determines that the tasks of all the printers are completed. When the tasks of all the printers are not completed (S90: NO), the processing returns to S20.

In response to determining that the tasks of all the printers are completed (S90: YES), in S95, the CPU 110 transmits a task completion notification indicating that the tasks of all the printers are completed to the administrator terminal 200. Then, the processing of FIG. 8 ends.

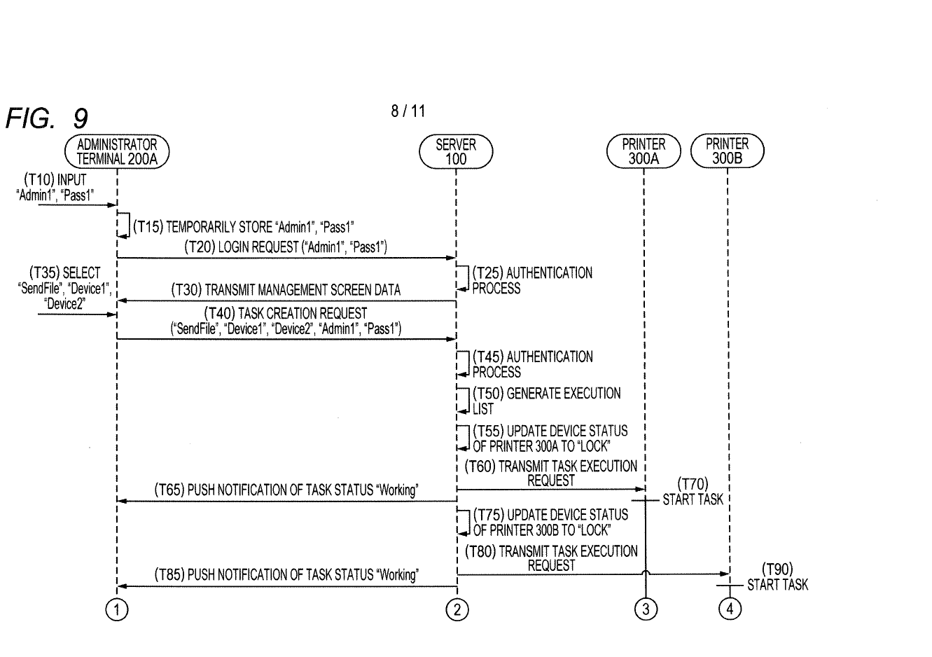

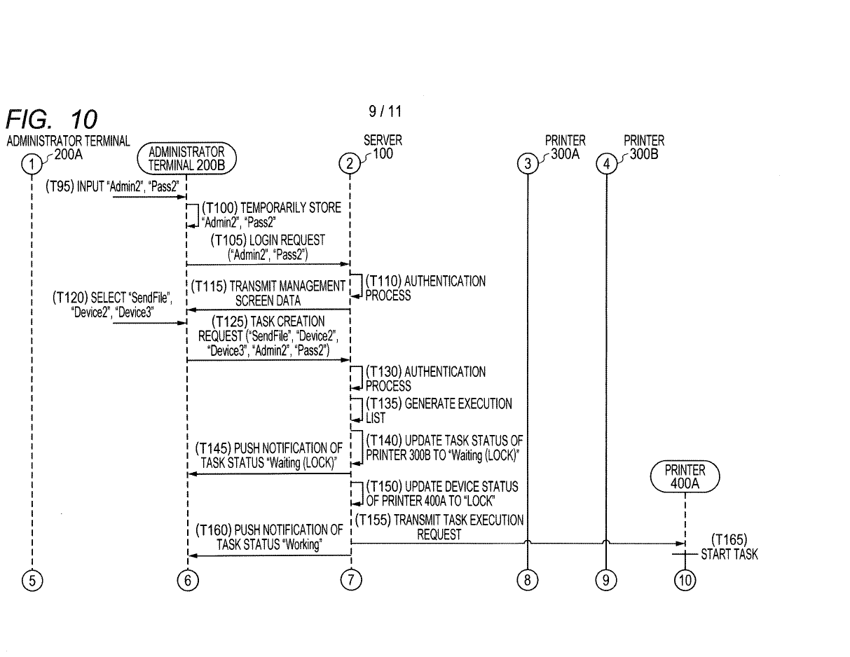

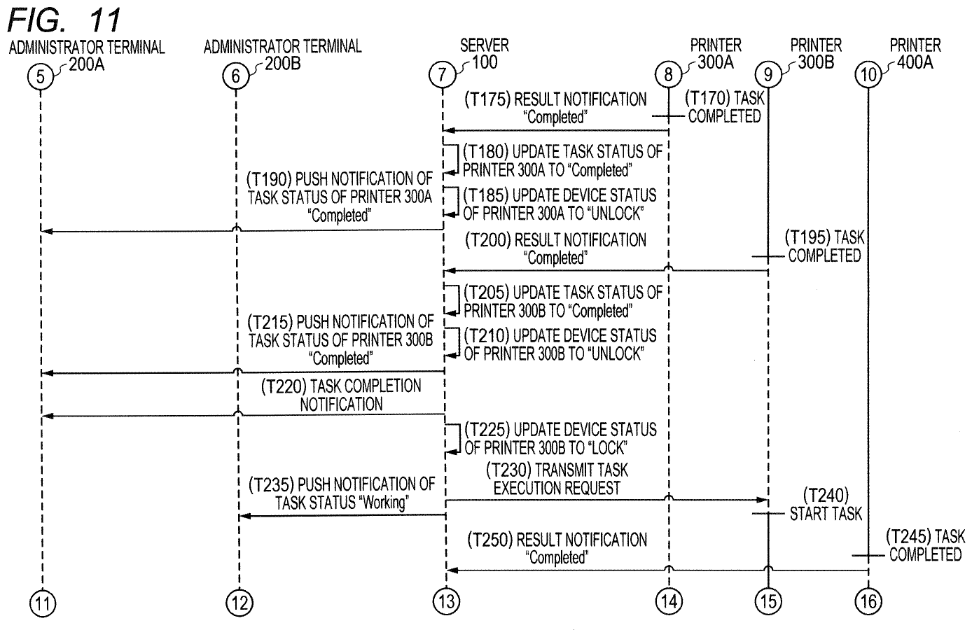

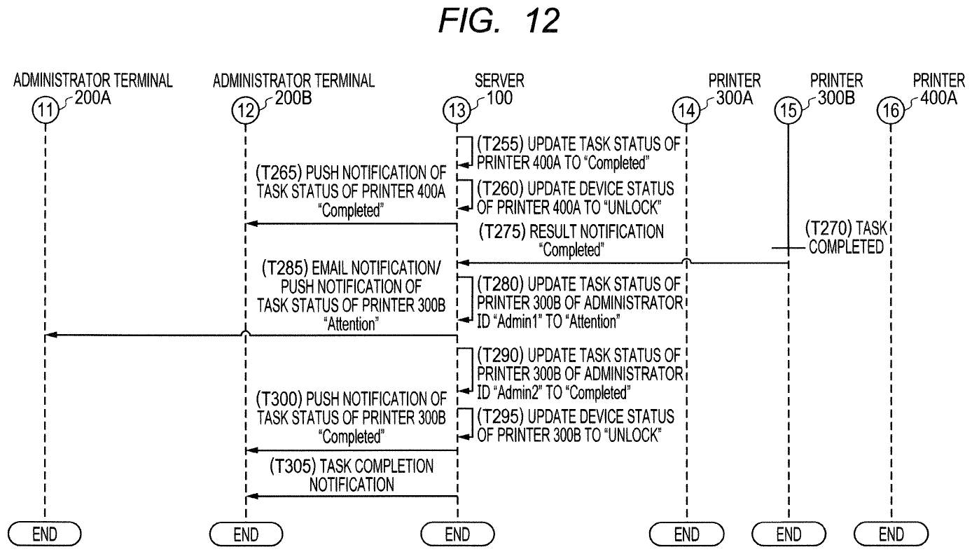

An example of a flow of processing will be described with reference to FIGS. 9 to 12. In this example, both an administrator using the administrator terminal 200A and an administrator using the administrator terminal 200B request execution of a task for the printers 300 and 400. Both administrators manage the printers 300 and 400 in cooperation. The server 100 has not received a task creation request, and nothing is stored in the execution list 126B. None of the printer 300A, the printer 300B, the printer 400A, and the printer 400B is executing a task, and the status management database 128 is in the state shown in FIG. 7A.

In T10, the administrator terminal 200A receives input of an administrator ID “Admin1” and a password “Pass1” from an administrator using the administrator terminal 200A. In T15, the administrator terminal 200A temporarily stores the administrator ID “Admin1” and the password “Pass1” in the volatile memory 230. In T20, the administrator terminal 200A transmits a login request including the administrator ID “Admin1” and the password “Pass1” to the server 100. In T20, the administrator terminal 200A also transmits a connection request for establishing bidirectional communication with the server 100 in accordance with the WebSocket protocol.

In T25, the server 100 executes an authentication process based on the administrator ID “Admin1” and the password “Pass1” included in the login request. In the authentication process, when the administrator ID “Admin1”, the password “Pass1”, and the authority “View” are stored in the administrator database 124 in association with one another, the CPU 110 determines that the authentication is successful. When the CPU 110 determines that the authentication is successful, in T30 the server 100 generates management screen data and transmits the management screen data to the administrator terminal 200A. Specifically, the server 100 extracts printer information of the device IDs “Device1” and “Device2” associated with the administrator ID “Admin1” from the device list 126A, and generates management screen data showing a list of printers managed by the administrator ID “Admin1”. Further, in T30, the server 100 establishes bidirectional communication with the administrator terminal 200A in accordance with the WebSocket protocol.

The administrator terminal 200A displays a management screen on the display 250. The management screen (not shown) displays a list of printers managed by the administrator with the administrator ID “Admin1” and buttons for selecting a task to be executed. In T35, the administrator terminal 200A receives, from the administrator using the administrator terminal 200A, selection of the printer 300A and the printer 300B as the printers that execute the task. Further, in T35, the administrator terminal 200A accepts selection of the file transmission task as the execution task.

In T40, the administrator terminal 200A transmits a task creation request to the server 100. The task creation request includes the execution task “SendFile”, the device ID “Device1” of the printer 300A, the device ID “Device2” of the printer 300B, the administrator ID “Admin1”, and the password “Pass1”.

In T45, the server 100 executes an authentication process based on the administrator ID “Admin1” and the password “Pass1” included in the task creation request. In the authentication process, when the administrator ID “Admin1”, the password “Pass1”, and the authority “Exe” are stored in the administrator database 124 in association with one another, the CPU 110 determines that the authentication is successful. When the CPU 110 determines that the authentication is successful, in T50, the server 100 generates the execution list 126B (S15). For example, the server 100 stores a new task ID “Task1”, the administrator ID “Admin1” included in the task creation request, the device ID “Device1”, and the execution task “SendFile” in the execution list 126B in association with one another. Further, the server 100 stores the task ID “Task1”, the administrator ID “Admin1”, the device ID “Device2”, and the execution task “SendFile” in the execution list 126B in association with one another. The task status is left blank.

In a case where the administrator ID included in the task creation request is “Admin3”, the authority “Exe” is not stored in association with the administrator ID “Admin3” in the administrator database 124, and thus the server 100 determines that the authorization has failed. When the CPU 110 determines that the authentication has failed, the processing after T50 is not executed, and the server 100 notifies the administrator terminal 200A that the authentication has failed.

In T55, the server 100 selects the printer 300A as the target device (S25) and updates the device status of the printer 300A to “LOCK” (S35). In T60, the server 100 updates the task status of the printer 300A to “Working” (S40), and transmits a task execution request to the printer 300A (S45). In T65, the server 100 transmits a push notification of the task status “Working” of the printer 300A to the administrator terminal 200A. In the administrator terminal 200A, the display 250 displays that the printer 300A is executing the file transmission task.

In T70, the printer 300A starts executing the task. Specifically, the printer 300A receives a file in which a setting value is described and updates the setting value. The setting value is, for example, a default print setting for executing printing on the printer 300A. The setting value may be a password for logging in to a web server function of the printer 300A including an embedded web server. That is, the setting value may be a setting related to maintenance and management of the printer 300A.

In T75, the server 100 selects the printer 300B as the target device (S25) and updates the device status of the printer 300B to “LOCK” (S35). In T80, the server 100 updates the task status of the printer 300B to “Working” (S40), and transmits a task execution request to the printer 300B (S45). In T85, the server 100 transmits a push notification of the task status “Working” of the printer 300B to the administrator terminal 200A. In the administrator terminal 200A, the display 250 displays that the printer 300B is executing the file transmission task.

In T90, the printer 300B starts executing the task. Specifically, the printer 300B receives a file in which a setting value is described and updates the setting value.

At the time when T80 is executed, the execution list 126B is in the state shown in FIG. 5A. The status management database 128 is in the state shown in FIG. 7B.

In T95, the administrator terminal 200B receives input of an administrator ID “Admin2” and a password “Pass2” from an administrator using the administrator terminal 200B. In T100, the administrator terminal 200B temporarily stores the administrator ID “Admin2” and the password “Pass2” in the volatile memory 230. In T105, the administrator terminal 200B transmits a login request including the administrator ID “Admin2” and the password “Pass2” to the server 100. In T105, the administrator terminal 200B also transmits a connection request for establishing bidirectional communication with the server 100 in accordance with the WebSocket protocol.

In T110, the server 100 executes an authentication process based on the administrator ID “Admin2” and the password “Pass2” included in the login request. In the authentication process, since the administrator ID “Admin2”, the password “Pass2”, and the authority “View” are stored in the administrator database 124 in association with one another, the CPU 110 determines that the authentication is successful, and in T115, the server 100 generates management screen data and transmits the management screen data to the administrator terminal 200B. Specifically, the server 100 extracts information of the device ID “Device2” and the device ID “Device3” associated with the administrator ID “Admin2” from the device list 126A, and generates management screen data indicating a list of printers managed by the administrator with the administrator ID “Admin2”. Further, in T115, the server 100 establishes bidirectional communication with the administrator terminal 200B in accordance with the WebSocket protocol.

The administrator terminal 200B displays a management screen on the display 250. The management screen (not shown) displays a list of printers managed by the administrator with the administrator ID “Admin2” and buttons for selecting tasks to be executed. In T120, the administrator terminal 200B accepts, from the administrator using the administrator terminal 200B, selection of the printer 300B and the printer 400A as the printer that executes the task. Further, in T120, the administrator terminal 200B accepts selection of the file transmission task as the execution task. In T125, the administrator terminal 200B transmits a task creation request to the server 100. The task creation request includes the execution task “SendFile”, the device ID “Device2” of the printer 300A, the device ID “Device3” of the printer 400A, the administrator ID “Admin2”, and the password “Pass2”.

In T130, the server 100 executes an authentication process based on the administrator ID “Admin2” and the password “Pass2” included in the task creation request. In the authentication process, since the administrator ID “Admin2”, the password “Pass2”, and the authority “Exe” are stored in the administrator database 124 in association with one another, the CPU 110 determines that the authentication is successful, and in T135, the server 100 generates the execution list 126B (S15). For example, the server 100 stores a new task ID “Task2”, the administrator ID “Admin2” included in the task creation request, the device ID “Device2”, and the execution task “SendFile” in the execution list 126B in association with one another. Further, the server 100 stores the task ID “Task2”, the administrator ID “Admin2”, the device ID “Device3”, and the execution task “SendFile” in the execution list 126B in association with one another. The task status is left blank.

In T140, the server 100 selects the printer 300B as the target device (S25). Since the status of the printer 300B is “LOCK” (S30: YES), in T140 the server 100 updates the task status of the printer 300B to “Waiting (LOCK)” (S33). In T145, the server 100 transmits a push notification of the task status “Waiting (LOCK)” of the printer 300B to the administrator terminal 200B. In the administrator terminal 200B, the display 250 displays that the printer 300B is executing a task by an administrator different from the administrator using the administrator terminal 200B, and the task by the administrator using the administrator terminal 200B cannot be executed.

In T150, the server 100 selects the printer 400A as the target device (S25) and updates the device status of the printer 400A to “LOCK” (S35). In T155, the server 100 updates the task status of the printer 400A to “Working” (S40), and transmits a task execution request to the printer 400A (S45). In T160, the server 100 transmits a push notification of the task status “Working” of the printer 400A to the administrator terminal 200B. In the administrator terminal 200B, the display 250 displays that the printer 400A is executing the file transmission task.

In T165, the printer 400A starts executing the task. Specifically, the printer 400A receives a file in which a setting value is described and updates the setting value.

At the time when T155 is executed, the execution list 126B is in the state shown in FIG. 5B. The status management database 128 is in the state shown in FIG. 7C.

In T170, the printer 300A successfully executes and completes the file transmission task by the administrator using the administrator terminal 200A. In T175, the printer 300A transmits a result notification “Completed” to the server 100.

In T180, since the printer 300A is not an execution completion device (S55: NO), the server 100 updates the task status of the file transmission task by the administrator using the administrator terminal 200A to “Completed” (S75). In T185, the server 100 updates the device status of the printer 300A to “UNLOCK” (S80). In T190, the server 100 transmits a push notification of the task status “Completed” of the printer 300A to the administrator terminal 200A. In the administrator terminal 200A, the display 250 displays that the printer 300A has properly executed the file transmission task.

In T195, the printer 300B successfully executes and completes the file transmission task by the administrator using the administrator terminal 200A. In T200, the printer 300B transmits a result notification “Completed” to the server 100.

In T205, since the printer 300B is not an execution completion device (S55: NO), the server 100 updates the task status of the file transmission task by the administrator using the administrator terminal 200A to “Completed” (S75). In T210, the server 100 updates the status of the printer 300B to “UNLOCK” (S80). In T215, the server 100 transmits a push notification of the task status “Completed” of the printer 300B to the administrator terminal 200A. In T220, since the task status of all the tasks having the task ID “Task1” are “Completed”, the server 100 determines that the tasks of all the printers have been completed (S90: YES), and transmits a task completion notification to the administrator terminal 200A by a push notification (S95). In the administrator terminal 200A, the display 250 displays that the printer 300B has properly executed the file transmission task and that the tasks of all the printers have been completed.

At the time when T210 is executed, the execution list 126B is in the state shown in FIG. 5C. The status management database 128 is in the state shown in FIG. 7D.

In T225, the server 100 again selects printer 300B as the target device (S25) and updates the device status of the printer 300B to “LOCK” (S35). In T230, the server 100 updates the task status of the printer 300B to “Working” (S40), and transmits a task execution request to the printer 300B (S45). In T235, the server 100 transmits a push notification of the task status “Working” of the printer 300B to the administrator terminal 200B. In the administrator terminal 200B, the display 250 displays that the printer 300B is executing the file transmission task.

In T240, the printer 300B starts executing the task. Specifically, the printer 300B receives a file in which a setting value is described and updates the setting value.

At the time when T230 is executed, the execution list 126B is in the state shown in FIG. 6A. The status management database 128 is in the state shown in FIG. 7E.

In T245, the printer 400A successfully executes and completes the file transmission task by the administrator using the administrator terminal 200B. In T250, the printer 400A transmits a result notification “Completed” to the server 100.

In T255, since the printer 400A is not an execution completion device (S55: NO), the server 100 updates the task status of the file transmission task by the administrator using the administrator terminal 200B to “Completed” (S75). In T260, the server 100 updates the device status of the printer 400A to “UNLOCK” (S80). In T265, the server 100 transmits a push notification of the task status “Completed” of the printer 400A to the administrator terminal 200B. In the administrator terminal 200B, the display 250 displays that the printer 400A has properly executed the file transmission task.

In T270, the printer 300B successfully executes and completes the file transmission task by the administrator using the administrator terminal 200B. Thus, the setting value updated by the administrator using the administrator terminal 200A at the time of completion of T195 is updated again by the administrator using the administrator terminal 200B. In T275, the printer 300B transmits a result notification “Completed” to the server 100.

As shown in FIG. 6A, the administrator ID “Admin1”, the device ID “Device2”, the executed task “SendFile”, and the task status “Completed” are stored in the execution list 126B in association with one another. That is, the completed task by the administrator using the administrator terminal 200A different from the administrator terminal 200B is stored. Thus, in T280, the server 100 determines that the printer 300B is the execution completion device (S55: YES) and that the administrator of the running task is different from the administrator of the completed task (S58: YES). Further, both the running task and the completed task are file transmission tasks. Thus, in T280, the server 100 determines that the completed task and the running task are related to the same function (S60: YES), and updates the task status of the completed task of the printer 300B to “Attention” (S65).

In T285, the server 100 transmits an email notification of the task status “Attention” of the completed task of the printer 300B to the administrator terminal 200A (S70). After an email application is activated by the administrator using the administrator terminal 200A, the administrator terminal 200A displays a text on the display 250 to call the administrator's attention to the execution status of the task.

In T290, the server 100 updates the task status of the running task of the printer 300B to “Completed” (S75). In T295, the server 100 updates the device status of the printer 300B to “UNLOCK” (S80). In T300, the server 100 transmits a push notification of the task status “Completed” of the running task of the printer 300B to the administrator terminal 200B. In T305, since the task status of all the tasks having the task ID “Task2” are “Completed”, the server 100 determines that the tasks of all the printers have been completed (S90: YES), and transmits a task completion notification to the administrator terminal 200B by a push notification (S95). In the administrator terminal 200B, the display 250 displays that the printer 300B has properly executed the file transmission task and that the tasks of all the printers have been completed.

(1) According to the present embodiment, the server 100 receives the task creation request for instructing the printer 300B to execute the file transmission task from the administrator terminal 200A (T40). In response to receiving the task creation request from the administrator terminal 200A, the server 100 transmits the task execution request for executing the file transmission task to the printer 300B (T80). After the task creation request is received from the administrator terminal 200A, the server 100 receives the task creation request from the administrator terminal 200B, the task creation request instructing both the printer 300B and the printer 400A to execute the file transmission task (T125). In response to receiving the task creation request from the administrator terminal 200B, the server 100 transmits the task execution request for executing the file transmission task to the printer 300B and the printer 400A (T155, T230). While the printer 300B is executing the file transmission task by the administrator using the administrator terminal 200A (the solid line portion of the printer 300B in FIGS. 9 to 11), the server 100 does not transmit, to the printer 300B, the task execution request for requesting execution of the file transmission task by the administrator using the administrator terminal 200B, and transmits the task execution request to the printer 400A that is not executing the file transmission task by the administrator using the administrator terminal 200A (T155). After the printer 300B completes the file transmission task by the administrator using the administrator terminal 200A (after T195), the server 100 transmits the task execution request (T230). Thus, even when the execution of the plurality of tasks is separately instructed, the device efficiently executes the plurality of tasks.

While a device with limited processing capabilities, such as a printer, is executing a task such as a firmware update, if requests to execute other tasks are received, the load may increase beyond the processing capabilities of the device. According to the present embodiment, while the printer 300B is executing the file transmission task by an administrator using the administrator terminal 200A, the task execution request is not transmitted, and thus, the load on the printer 300B is reduced.

(2) According to the present embodiment, the status management database 128 of the server 100 stores either the character string “UNLOCK” indicating that the printer is in a status of accepting the task execution request or the character string “LOCK” indicating that the printer is in a status of not accepting the task execution request, in association with the device ID for identifying the printer. While the printer 300B is executing the file transmission task by an administrator using the administrator terminal 200A (the solid line portion of the printer 300B in FIGS. 9 to 11), the character string “LOCK” is stored in the status management database 128 in association with the device ID “Device2” identifying the printer 300B (FIG. 7B). While the printer 300B is not executing the file transmission task by an administrator using the administrator terminal 200A, the character string “UNLOCK” is stored in the status management database 128 in association with the device ID “Device2” (FIGS. 7A, 7D, and 7F). When the character string “LOCK” is stored in the status management database 128 in association with the device ID “Device2” (S30: YES), the server 100 does not transmit, to the printer 300B, the task execution request for requesting execution of the file transmission task by the administrator using the administrator terminal 200B. When the character string “UNLOCK” is stored in the status management database 128 in association with the device ID “Device2” (S30: NO), the server 100 transmits the task execution request to the printer 300B (T230). This enables the server 100 to appropriately determine whether the printers 300 and 400 are in the status of accepting the task execution request.

(3) According to the present embodiment, when the character string “LOCK” is stored in the status management database 128 in association with the device ID “Device2” (S30: YES), the server 100 transmits, to the administrator terminal 200B, a push notification of the task status “Waiting (LOCK)” indicating that the printer 300B is in a status where the task cannot be executed (T145). When the character string “UNLOCK” is stored in the status management database 128 in association with the device ID “Device2” (S30: NO), the server 100 transmits, to the administrator terminal 200B, a push notification of the task status “Working” indicating that the printer is executing the task (T235). This enables the administrator using the administrator terminal 200B to recognize the reason why the execution of the task is not started in the printer 300B.

(4) According to the present embodiment, the server 100 transmits the execution status of the task in the printers 300 and 400 to the administrator terminal 200 (S85). The execution status of the task includes “Completed” indicating that the printer has properly executed and completed the task identified by the execution task, “Attention” indicating that the administrator is to be alerted to the execution status of the task, and “Error” indicating that the printer has failed the task identified by the execution task. This enables the administrator using the administrator terminal 200 to confirm whether the task has been properly executed. When there is a possibility that the task is not properly executed, the notification content to the administrator is switchable between two types of notifications of “Attention” and “Error”.

(5) According to the present embodiment, when the printer 300B completes the execution of the file transmission task by the administrator using the administrator terminal 200A (T195), the server 100 transmits a push notification of the task status “Completed” of the printer 300B to the administrator terminal 200A (T215). Thereafter, when the printer 300B completes the execution of the file transmission task by the administrator using the administrator terminal 200B (T270), the server 100 transmits, to the administrator terminal 200A, an email notification of the task status “Attention” of the printer 300B of the completed task by the administrator using the administrator terminal 200A (T285).

The file transmission task is a task in which the server 100 transmits a file in which a setting value is described to a printer and causes the printer to update the setting value. If the administrator using the administrator terminal 200A causes the printer 300B to update the setting value and then the administrator using the administrator terminal 200B causes the printer 300B to update the setting value, the setting value set by the administrator using the administrator terminal 200A is overwritten. Nevertheless, if the management screen of the administrator terminal 200A still displays that the printer 300B has properly executed the file transmission task, the administrator using the administrator terminal 200A may misunderstand the execution status of the task. According to the present embodiment, after the setting value set by the administrator using the administrator terminal 200A is overwritten, the task status “Attention” is transmitted to the administrator terminal 200A, which enables the administrator using the administrator terminal 200A to recognize that the execution status of the task is to be checked.

(6) According to the present embodiment, when the task creation request is received by the administrator using the administrator terminal 200B, who is different from the administrator using the administrator terminal 200A (T125), the server 100 transmits, to the administrator terminal 200A, an email notification of the task status “Attention” of the completed task of the printer 300B (T285). When the administrator using the administrator terminal 200B does not notify that the task status has been updated, the administrator using the administrator terminal 200A is likely to misunderstand the actual task status. For example, even though the setting value is rewritten by the administrator using the administrator terminal 200B, the administrator using the administrator terminal 200A is likely to misunderstand that the setting value set by the administrator is still set. According to the present embodiment, the possibility that the administrator misrecognizes the actual task status is reduced.

(7) According to the present embodiment, the server 100 transmits, to the administrator terminal 200A, a push notification of the task status “Completed” of the printer 300B by the bidirectional communication in accordance with the WebSocket (T215). Thereafter, the server 100 transmits, to the administrator terminal 200A, an email notification of the task status “Attention” of the printer 300B of the completed task by the administrator using the administrator terminal 200A (T285). By transmitting notifications using different notification methods, the administrator using the administrator terminal 200A easily notices the notification.

The bidirectional communication in accordance with WebSocket is disconnected at the time when the administrator using the administrator terminal 200A logs out from the management screen, and the server 100 cannot transmit push notifications. According to the present embodiment, the email notification enables the administrator using the administrator terminal 200A to recognize that the execution status of the task is to be checked even after the administrator logs out from the management screen.

(8) According to the present embodiment, the character string “Exe” indicating that the administrator is permitted to instruct the execution of the task is stored in the administrator database 124 in association with the administrator ID for identifying the administrator. Thus, in a case where the printers 300 and 400 are managed in a company, for example, the administrator changes functions that are permitted to be executed according to the job authority of the administrator.

While the disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

(1) The task creation request in T40 and the task creation request in T125 may be transmitted by the same administrator terminal 200A.

(2) The task creation request in T40 and the task creation request in T125 may be requests for instructing execution of a firmware update task of the printer or may be requests for instructing execution of a backup task. That is, the task creation request may include the character string “FirmUpdate” or the character string “Backup” instead of the character string “SendFile”.

(3) The task creation request in T125 may be transmitted substantially at the same time as the server 100 transmits the task execution request to the printer 300A and the printer 300B. In this case, the processing shown in the flowchart of FIG. 8 is executed in parallel.

(4) The task status “Attention” may be omitted. In this case, in S65, the task status of the completed task is updated to “Error”.

(5) The determination of S58 may be omitted. That is, when the administrator of the running task and the administrator of the completed task are the same, the processing of S65 may be executed.

(6) The notification of S70 may be a push notification by bidirectional communication in accordance with the WebSocket. The notification of S70 may be a combination of a push notification and an email notification.

(7) The content stored in the execution list 126B may be deleted when a particular time has elapsed. For example, in a case where a setting value set one year ago is updated and a notification indicating that the task status has been updated is transmitted (S70), the notification is likely to be unnecessary for the administrator. According to the present modification, an unnecessary notification to the administrator is prevented.

(8) The server 100 and the administrator terminal 200 may not establish bidirectional communication. In this case, the administrator terminal 200 receives a notification from the server 100 by a polling method. That is, the administrator terminal 200 periodically transmits an HTTP request for requesting a task status to the server 100. The server 100 transmits the task status to the administrator terminal 200 as an HTTP response.

The firmware update task, the file transmission task, and the backup task are examples of “particular task”. The printer 300B is an example of “first device”. The printer 400A is an example of “second device”. The server 100 is an example of “server”. The CPU 110 is an example of “controller”. The management system 1 is an example of “management system”. The task creation request in T40 is an example of “first execution instruction”, and the file transmission task by the task creation request in T40 is an example of “first task”. T40 is an example of “first reception process” executed by “first reception unit”. The task execution request in T80 is an example of “first execution request”, and S45 is an example of “first transmission process” executed by “first transmission unit”. The task creation request in T125 is an example of “second execution instruction”, and the file transmission task by the task creation request in T125 is an example of “second task”. T125 is an example of “second reception processing” executed by “second reception unit”. The task execution request in T155 and the task execution request in T230 are examples of “second execution request”, and S45 is an example of “second transmission process” executed by “second transmission unit”. T90 is an example of a process executed by “first task execution unit”. T165 and T240 are examples of the process executed by “second task execution unit”. The device ID is an example of “device identification information”. The character string “LOCK” is an example of “lock information”. The character string “UNLOCK” is an example of “unlock information”. The status management database 128 is an example of “device status storage unit”. The administrator terminal 200A is an example of “first administrator terminal”. The display 250 is an example of “display”. The CPU 210 is an example of “display control unit”. The notifications transmitted by S50, S65, and S85 are examples of “status notifications”, and S50 is an example of a process executed by “first notification unit”. The notification including the task status “Waiting (LOCK)” is an example of “waiting notification”. The notification including the task status “Working” is an example of “execution notification”. S65 and S85 are examples of the process executed by “notify of second user information”. The notification including the task status “Completed” is an example of “first type notification”. The notification including the task status “Attention” or the task status “Error” is an example of “second type notification”. The notification including the task status “Error” is an example of “failure notification”. The notification including the task status “Attention” is an example of “attention notification”. T125 is an example of a process executed by “first instruction unit”. The administrator terminal 200B is an example of “second administrator terminal”. The push notification by the bidirectional communication in accordance with the WebSocket is an example of “first notification method”. The email is an example of “second notification method”. The administrator ID is an example of “administrator identification information”. The character string “Exe” is an example of “execution authority”. The administrator database 124 is an example of “authority storage unit”.

What is claimed is

1. A management system comprising:
a plurality of devices configured to execute a particular task, the plurality of devices including a first device and a second device different from the first device; and
a server configured to perform:
receiving a first execution instruction from outside, the first execution instruction instructing execution of a first task that is the particular task for the first device;
in response to receiving the first execution instruction, transmitting a first execution request to the first device, the first execution request requesting execution of the first task;
after receiving the first execution instruction, receiving a second execution instruction from outside, the second execution instruction instructing execution of a second task that is the particular task for both the first device and the second device; and
in response to receiving the second execution instruction, transmitting a second execution request to the first device and the second device, the second execution request requesting execution of the second task,
the first device configured to perform:
in response to receiving the first execution request, executing the first task;
each of the first device and the second device configured to perform:
in response to receiving the second execution request, executing the second task,
the transmitting the second execution request including:
while the first device is executing the first task, not transmitting the second execution request to the first device and transmitting the second execution request to the second device that is not executing the first task; and
after the first device completes execution of the first task, transmitting the second execution request to the first device.

2. The management system according to claim 1, wherein the server includes a memory configured to store either lock information or unlock information in association with device identification information identifying a device, the lock information indicating that the device is in a status of not accepting an execution request of the particular task, the unlock information indicating that the device is in a status of accepting an execution request of the particular task;
wherein the server is configured to:
while the first device is executing the first task, store, in the memory, the lock information in association with first device identification information, the first device identification information being the device identification information identifying the first device; and
while the first device is not executing the first task, store, in the memory, the unlock information in association with the first device identification information; and
wherein the transmitting the second execution request includes:
in a case where the memory stores the lock information in association with the first device identification information, not transmitting the second execution request to the first device; and
in a case where the memory stores the unlock information in association with the first device identification information, transmitting the second execution request to the first device.

3. The management system according to claim 1, further comprising:
a first administrator terminal configured to, in response to receiving a status notification indicating an execution status of a task in a device, control a display to display a content of the status notification,
wherein the server includes a memory configured to store either lock information or unlock information in association with device identification information identifying a device, the lock information indicating that the device is in a status of not accepting an execution request of the particular task, the unlock information indicating that the device is in a status of accepting an execution request of the particular task; and
wherein the server is configured to:
in a case where the memory stores the lock information in association with the device identification information, transmit a waiting notification to the first administrator terminal, the waiting notification being the status notification indicating that the device is unable to execute a task; and
in a case where the memory stores the unlock information in association with the device identification information, transmit an execution notification to the first administrator terminal, the execution notification being the status notification indicating that the device is executing the task.

4. The management system according to claim 1, further comprising:
a first administrator terminal configured to, in response to receiving a status notification indicating an execution status of a task in a device, control a display to display a content of the status notification,
wherein the server is configured to transmit the status notification to the first administrator terminal, the status notification including a first-type notification and a second-type notification, the first-type notification indicating that a device has executed a task properly, the second-type notification indicating that there is a possibility that the device has not executed a task properly.

5. The management system according to claim 4, wherein the second-type notification includes a failure notification and an attention notification, the failure notification indicating the device has failed in execution of the task, the attention notification alerting an administrator.

6. The management system according to claim 4, wherein the first administrator terminal is configured to transmit the first execution instruction to the server;
wherein the server is configured to:
in a case where the first device has completed execution of the first task, transmit the first-type notification to the first administrator terminal as the status notification indicating an execution status of the first task in the first device; and
after transmitting the first-type notification to the first administrator terminal, in a case where the first device has completed execution of the second task that is a task relating to a same function as the first task, transmit the second-type notification to the first administrator terminal as the status notification indicating the execution status of the first task in the first device; and
wherein the first administrator terminal is configured to:
in response to receiving the first-type notification, control the display to display a content of the first-type notification; and
after displaying the content of the first-type notification, in response to receiving the second-type notification, control the display to display a content of the second-type notification.

7. The management system according to claim 6, wherein the server is configured to:
in a case where the second execution instruction is received from a second administrator terminal different from the first administrator terminal, transmit the second-type notification to the first administrator terminal.

8. The management system according to claim 6, wherein the server is configured to:
transmit the first-type notification to the first administrator terminal in a first notification method; and
transmit the second-type notification to the first administrator terminal in a second notification method different from the first notification method.

9. The management system according to claim 1, wherein the server includes a memory configured to store an execution authority in association with administrator identification information identifying an administrator, the execution authority indicating whether the administrator is permitted to instruct execution of a task.

10. The management system according to claim 6, wherein the server is configured to:
in a case where a particular time or longer has elapsed from transmission of the first-type notification, not transmit the second-type notification to the first administrator terminal.

11. A non-transitory computer-readable storage medium storing a set of program instructions for a server comprising a controller, the server being configured to be connected to a plurality of devices for communication, the plurality of devices being configured to execute a particular task, the plurality of devices including a first device and a second device, the set of program instructions, when executed by the controller, causing the server to perform:
receiving a first execution instruction from outside, the first execution instruction instructing execution of a first task that is the particular task for the first device;
in response to receiving the first execution instruction, transmitting a first execution request to the first device, the first execution request requesting execution of the first task;
after receiving the first execution instruction, receiving a second execution instruction from outside, the second execution instruction instructing execution of a second task that is the particular task for both the first device and the second device; and
in response to receiving the second execution instruction, transmitting a second execution request to the first device and the second device, the second execution request requesting execution of the second task,
the transmitting the second execution request including:
while the first device is executing the first task, not transmitting the second execution request to the first device and transmitting the second execution request to the second device that is not executing the first task; and
after the first device completes execution of the first task, transmitting the second execution request to the first device.

12. A server configured to be connected to a plurality of devices for communication, the plurality of devices being configured to execute a particular task, the plurality of devices including a first device and a second device, the server comprising:
a controller configured to perform:
receiving a first execution instruction from outside, the first execution instruction instructing execution of a first task that is the particular task for the first device;
in response to receiving the first execution instruction, transmitting a first execution request to the first device, the first execution request requesting execution of the first task;
after receiving the first execution instruction, receiving a second execution instruction from outside, the second execution instruction instructing execution of a second task that is the particular task for both the first device and the second device; and
in response to receiving the second execution instruction, transmitting a second execution request to the first device and the second device, the second execution request requesting execution of the second task,
the transmitting the second execution request including:
while the first device is executing the first task, not transmitting the second execution request to the first device and transmitting the second execution request to the second device that is not executing the first task; and
after the first device completes execution of the first task, transmitting the second execution request to the first device.

13. The server according to claim 12, further comprising a memory configured to store either lock information or unlock information in association with device identification information identifying a device, the lock information indicating that the device is in a status of not accepting an execution request of the particular task, the unlock information indicating that the device is in a status of accepting an execution request of the particular task,
wherein the controller is configured to:
while the first device is executing the first task, store, in the memory, the lock information in association with first device identification information, the first device identification information being the device identification information identifying the first device; and
while the first device is not executing the first task, store, in the memory, the unlock information in association with the first device identification information; and
wherein the transmitting the second execution request includes:
in a case where the memory stores the lock information in association with the first device identification information, not transmitting the second execution request to the first device; and
in a case where the memory stores the unlock information in association with the first device identification information, transmitting the second execution request to the first device.

14. The server according to claim 12, further comprising a memory configured to store either lock information or unlock information in association with device identification information identifying a device, the lock information indicating that the device is in a status of not accepting an execution request of the particular task, the unlock information indicating that the device is in a status of accepting an execution request of the particular task,
wherein the controller is configured to:
in a case where the memory stores the lock information in association with the device identification information, transmit a waiting notification to the first administrator terminal, the waiting notification being a status notification indicating that the device is unable to execute a task, the status notification indicating an execution status of the task in the device; and
in a case where the memory stores the unlock information in association with the device identification information, transmit an execution notification to the first administrator terminal, the execution notification being the status notification indicating that the device is executing the task.

15. The server according to claim 12, wherein the controller is configured to:
transmit a status notification to a first administrator terminal, the status notification indicating an execution status of a task in a device, the status notification including a first-type notification and a second-type notification, the first-type notification indicating that the device has executed the task properly, the second-type notification indicating that there is a possibility that the device has not executed the task properly.

16. The server according to claim 15, wherein the second-type notification includes a failure notification and an attention notification, the failure notification indicating the device has failed in execution of the task, the attention notification alerting an administrator.

17. The server according to claim 15, wherein the controller is configured to:
in a case where the first device has completed execution of the first task, transmit the first-type notification to the first administrator terminal as the status notification indicating an execution status of the first task in the first device; and
after transmitting the first-type notification to the first administrator terminal, in a case where the first device has completed execution of the second task that is a task relating to a same function as the first task, transmit the second-type notification to the first administrator terminal as the status notification indicating the execution status of the first task in the first device.

18. The server according to claim 17, wherein the controller is configured to:
in a case where the second execution instruction is received from a second administrator terminal different from the first administrator terminal, transmit the second-type notification to the first administrator terminal.

19. The server according to claim 17, wherein the controller is configured to:
transmit the first-type notification to the first administrator terminal in a first notification method; and
transmit the second-type notification to the first administrator terminal in a second notification method different from the first notification method.

20. The server according to claim 12, further comprising a memory configured to store an execution authority in association with administrator identification information identifying an administrator, the execution authority indicating whether the administrator is permitted to instruct execution of a task.
